(19) United States
(12) Patent Application Publication
(10) Pub. No.: US 2010/0207063 A1
(43) Pub. Date: Aug. 19, 2010

(54) Gentle Bleach

(76) Inventors: Carlos Malet, Sant Boi de Llobregat (ES); Mercedes Mendoza Cruz, Barcelona (ES); Miguel Osset, Sant Pere de Vilamajor (ES)

Correspondence Address: Henkel Corporation, 10 Finderne Avenue, Bridgewater, NJ, 08807, US

(21) Appl. No.: 12/687,968

(22) Filed: Jan. 15, 2010

Related U.S. Application Data
(63) Continuation of application No. PCT/EP2008/058744, filed on Jul. 7, 2008.

(30) Foreign Application Priority Data
Jul. 20, 2007 (DE) 10 2007 034 539.0

(51) Int. Cl. C11D 3/395

(52) U.S. Cl. 252/187.25; 252/187.24

(57) ABSTRACT

Improvement in the gentleness of fabric treatment in the laundering of textiles with hypochlorite bleaches. This is accomplished with a liquid, aqueous hypochlorite bleach comprising polyolefin wax, chelating agent(s), surfactant and an odorant chosen from diphenylmethane, diphenyl oxide, 2-methyl naphthyl ether and mixtures thereof.

### CROSS REFERENCE TO RELATED APPLICATIONS

The present application is a continuation of International Application No. PCT/EP2008/058744 filed 7 Jul. 2008, which claim priority to German Patent Application No. 10 2007 034 539.0 filed 20 Jul. 2007.

The present invention relates to hypochlorite bleaching agents which offer improved gentleness of fabric treatment in the laundering of textiles through the optimization of active ingredients additionally contained therein.

Efficient cleaning is one requirement influencing acceptance of washing and cleaning agents by the consumer. This requires the provision of agents having broad stain removal potential which can, for example, remove oily and greasy soiling from textiles or from hard surfaces such as floor or wall tiles. In order to satisfy this requirement, agents containing inter alia hypochlorite bleaching agent have been developed, wherein the hypochlorite as a strong oxidizing agent contributes towards chemical breakdown, decomposition and removal of the soiling. Another advantage of the use of hypochlorite is that it acts as an effective disinfectant. However, some consumers consider hypochlorite-containing agents to be too aggressive, whether to textiles or to human skin. Further, prolonged use of hypochlorite-containing washing agents can lead to yellowing of certain textiles, especially white textiles. In some circumstances a reduction in the softness (“stiffening”) of the textiles can also be observed.

Another disadvantage with hypochlorite is that after contact with human skin (as inevitably occurs when such agents are used with the bare hands for hand laundering or for cleaning hard surfaces and which cannot always be avoided even if gloves are worn), an odor is left on the skin which cannot always be completely removed even after washing repeatedly with water.

U.S. Pat. No. 7,214,652 B1 discloses a liquid hypochlorite-containing agent containing a plasticizer emulsion and which is free from optical brighteners. The plasticizer emulsion is based on polyethylene or polypropylene and contains an anionic surfactant from the class of di-(alkyl sulfonylphenyl)oxides.

European Patent Application No. 0 606 707 A describes agents containing a polymer component together with a hypochlorite compound, and which lead to a reduction in disagreeable odors from both the agent and from the surfaces cleaned with it. This could be attributable to the high viscosity of these agents, in that compounds responsible for the disadvantageous odor possibly become trapped in vesicles.

European Patent Application No. 0 812 909 A1 describes the use of polycarboxylate polymers in hypochlorite-containing bleaching agents to prevent unpleasant odors resulting from contact between such agents and surfaces of the skin.

European Patent Application No. 0 622 451 A also deals with the problem of odor formation during and after use of chlorine-containing agents, and proposes use of a perfume. This, however, raises problems in that firstly, only a few scents are stable in the presence of the strong oxidizing power of chlorine-based bleaching agents, and secondly, the odor of chlorine is very strong and can be masked by a perfume only with difficulty. EP 0 622 451 proposes using in such agents 0.000002 wt. % to 2 wt. % of bleach-resistant scents chosen from acetals, aldehydes, esters, alcohols, ketones, ethers, nitriles and terpenes.

Aqueous fabric softener dispersions based on esterquats and containing polyolefin waxes as thickeners are known from German Patent Application No. DE 44 35 386 A1.

A subjective impression of textile care using hypochlorite-containing agents cannot be emphatically created in the consumer by means of the prior art. Even if the addition of polyolefin wax to hypochlorite-containing bleaching agents brings about an improvement in the properties of the textiles treated with these bleaching agents, in particular, a softer feel to the textiles, from the consumer's perspective this does not outweigh the disadvantages of the risk of yellowing and the worsening of the odor, as well as the perceived aggressiveness of the hypochlorite.

In seeking to alleviate this problem, the invention provides a liquid aqueous hypochlorite-containing bleaching agent containing polyolefin wax, a fragrance chosen from diphenyl methane, diphenyl oxide, 2-methyl naphthyl ether and mixtures thereof, chelating agent and surfactant.

Use of agents having such a composition for laundering laundry items brings about not only an objectively measurable cleaning result but also a perceptible “feel-good effect” for the user by combination of the soft feel of the laundry and a pleasant scent (or at least an absence of the “chlorine odor” which is often negatively perceived), which is not diminished by a yellowing of the laundry item.

Polyolefin waxes contained in the agents according to the invention are understood to be predominantly linear polyolefins having a waxy nature, in particular, products having relatively low molecular masses in a range of from 500 to 20,000. As a rule, polyolefin waxes are produced by direct low-pressure polymerization or, preferably, high-pressure polymerization of the monomers, or by selective depolymerization of products having higher molecular masses. Use of modified polyolefin waxes such as those produced by copolymerization of ethylene with other suitable monomers (e.g., vinyl acetate or acrylic acid) is also possible. The dispersibility of polyolefins can be improved by oxidative surface treatment. Preferably used partially oxidized polyolefin waxes can be produced by polymerization of olefins, in particular ethylene, preferably in the absence of a catalyst, with premature termination of polymerization followed by partial oxidation, for example, by the introduction of air, or by copolymerization of olefins, in particular ethylene, with other suitable monomers such as acrylic acid, the molar proportion of acrylic acid units preferably not exceeding 20%, in particular 10%.

Use of high-density polyethylene wax having an average molecular mass in a range of from 500 to 10,000 and in particular, 2000 to 5000 is preferred. Cationic or pseudo-cationic polyethylene waxes can also be used if desired.

Polyolefin waxes are conventionally sold as aqueous dispersions having a solids content of 1 wt. % to 25 wt. %, in particular 2 wt. % to 15 wt. %. They generally contain small amounts of dispersing agents, for example, anionic or non-ionic surfactants, polyolefin dispersions stabilized by non-ionic surfactants preferably being used in the context of the present invention.

An agent according to the invention preferably contains 0.01 wt. % to 10 wt. %, in particular 0.1 wt. % to 2 wt. %, of polyolefin wax.

Surprisingly, it was found that the combination of optionally partially oxidized polyolefin waxes with the cited fragrances which reduce odor associated with chlorine bleaching agent on human skin that has come into contact with hypochlorite-containing agents also brings about a further enhancement of the positive textile properties after the use of the agent.

The present invention therefore also provides a method or use of fragrances for reducing the odor of chlorine bleaching agent on human skin that has come into contact with an agent containing chlorine bleaching agent and polyolefin wax. The fragrance is chosen from diphenyl methane, diphenyl oxide, 2-methyl naphthyl ether and mixtures thereof. In a preferred aspect, use on the skin is that on a human hand.

The fragrance preferably contains a combination of diphenyl methane and diphenyl oxide in a weight ratio of 1:1 to 1:50, in particular 1:10 to 1:5. It also preferably contains a combination of diphenyl methane and 2-methyl naphthyl ether in a weight ratio of 50:1 to 1:10, in particular 5:1 to 1:1. It is also preferable for the fragrance to contain a combination of diphenyl oxide and 2-methyl naphthyl ether in a weight ratio of 250:1 to 1:1, in particular 50:1 to 5:1.

The cited fragrance can be applied as such, or in the form of a preparation containing it to the areas of the skin that have come into contact with the chlorine-containing agent after the use of said agent. It is preferable, however, for the fragrance already to be a part of the composition containing the chlorine bleaching agent, for example, part of an agent according to the invention.

The invention also provides a method for bleaching soiling on textiles and/or hard surfaces in which an agent according to the invention is used.

An agent according to the invention can be an aqueous liquid which can be used on a textile or hard surface undiluted or optionally after mixing with water and which preferably contains 0.5 wt. % to 10 wt. %, in particular 1 wt. % to 6 wt. %, of alkali metal hypochlorite, in particular sodium hypochlorite.

An agent according to the invention preferably contains 0.0005 wt. % to 0.005 wt. % of diphenyl methane, 0.005 wt. % to 0.025 wt. % of diphenyl oxide, and/or 0.0001 wt. % to 0.005 wt. % of 2-methyl naphthyl ether.

A composition according to the invention preferably contains 0.1 wt. % to 2 wt. % of alkali metal hydroxide and up to 5 wt. % of bleach-resistant surfactant, in particular, betaine, amine oxide and/or alkyl ether sulfate.

Particularly preferred betaines are those of the general formula I

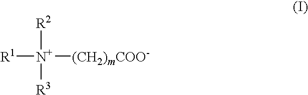

wherein R¹ is an alkyl or alkenyl group having 6 to 22 carbon atoms or an R⁴CO—NH—(CH₂)ₙ-group, R² is hydrogen or an alkyl group having 1 to 4 carbon atoms, R³ is hydrogen or an alkyl group having 1 to 4 carbon atoms, R⁴ is an alkyl or alkenyl group having 6 to 22 carbon atoms, m is a number from 1 to 6 and n is a number from 1 to 3. Examples of particularly suitable representatives of this class of surfactants encompass C₁₂₋₁₈ alkyl dimethyl betaine, commercially available as coconut betaine, and C₁₀₋₁₆ alkyl dimethyl betaine, commercially available as lauryl betaine. A further class of particularly preferred surfactants are the alkyl ether sulfates obtainable by reacting alcohols (preferably having 6 to 22 carbon atoms) with alkylene oxides, in particular ethylene oxide, with subsequent sulfation and neutralization, in particular a C₁₂₋₁₄ fatty alcohol ether sulfate alkoxylated with 2 equivalents of ethylene oxide. In the ether sulfates the corresponding cation is preferably sodium. A further class of particularly preferred surfactants are the amine oxides bearing at least one alkyl residue having 6 to 22 C atoms and up to two shorter alkyl residues having 1 to 4 C atoms, which can optionally also be hydroxy-substituted, at the nitrogen atom of the NO grouping. The agents according to the invention can additionally also contain further surfactants if desired, preferably in amounts not exceeding 1 wt. %. Examples include in particular soaps (alkali salts, in particular sodium and/or potassium salts of fatty acids having preferably 12 to 18 C atoms). Surfactants in total are preferably included in agents according to the invention in amounts of up to 5 wt. %, in particular 0.01 wt. % to 3 wt. %.

Preparations according to the invention additionally contain chelating agents, in particular organophosphonic acid and/or phosphonate, preferably alkyl phosphonic acids, and of these in particular those having at least one amine oxide substituent at the alkyl group, referred to here as amine oxide phosphonic acids, polyacrylic acids and/or polyacrylic acids containing phosphono groups, which can also be present in the form of their alkali salts. The incorporation of such complexing agents surprisingly leads to particularly good retention of the color impression of white textiles treated with the agent containing them. Amine oxide phosphonic acids are normally produced by oxidizing aminoalkyl phosphonic acids. They preferably belong to the group of compounds according to the general formula (II)

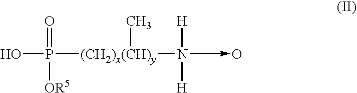

wherein R⁵ is hydrogen, a —(CH₂)ₓ(CHCH₃)_{y}—NH₂—>O group or an alkali metal; x is a number from 1 to 4; and y is 0 or 1. Amine oxide based on aminotrimethylene phosphonic acid is one of the particularly preferred amine oxide phosphonic acids. Agents according to the invention preferably contain 0.01 wt. % to 2 wt. % of chelating agent.

The agents preferably contain 0.5 wt. % to 2 wt. % of silicate, in particular, alkali metal silicate. They can additionally or alternatively contain carbonate, in particular, alkali metal carbonate, in amounts of preferably 0.1 wt. % to 2 wt. %.

Agents according to the invention can contain dyes or pigments if desired.

Agents according to the invention can be produced simply by mixing water with the aforementioned constituents in the specified amounts. They can be used as such, or diluted with water, for example, in amounts of 1 part by volume to 200 parts by volume, in particular, 2 parts by volume to 150 parts by volume, per 1 part by volume of the agent, in machine or hand textile laundering processes or in textile pretreatment prior to or instead of a laundering process (i.e., as a stain remover). Their corresponding use to clean hard surfaces is also possible.

### EXAMPLES

Agents having the compositions shown in the following Table (amounts in wt. %) were used in concentrations of 0.75 wt. % each in aqueous washing liquors to launder cotton towels (liquor ratio 1:20). After 20 minutes, the washing liquor was diluted with water to twice its volume and the towels were spun and air-dried.

| | M1 | M2 |
|---|---|---|
| NaOCl | 2 | 3.24 |
| NaOH | 1.25 | 1.25 |
| Fatty alkyl ether sulfate | 1 | 2.1 |
| Lauryl dimethylamine-N-oxide | 0.5 | — |
| Fatty acid | 0.25 | — |
| Aminotrimethylene phosphonic acid-N- | 0.6 | 0.1 |
| oxide | | |
| Sodium silicate | 2 | — |
| Polyethylene wax | 0.2 | 0.2 |
| Fragrance* | 0.025 | 0.01 |

| | |
|---|---|
| Water | up to 100 |

*Mixture of diphenyl methane, diphenyl oxide and 2-methyl naphthyl ether

Towel softness was determined by a panel of experienced testers in a paired comparison with towels washed otherwise identically but with agents lacking the polyethylene wax, the fragrance, the chelating agent or all three of the cited active ingredients. Towels laundered with the agents according to the invention were rated better by the test panel as a whole by an average of 2 units.

Although the present invention has been described in detail, it is to be clearly understood that the same is by way of illustration and example only, and is not to be taken as a limitation. The spirit and scope of the present invention are to be limited only by the terms of any claims presented hereafter.

We claim:

1. Bleaching agent comprising:
hypochlorite,
polyolefin wax,
chelating agent,
surfactant, and
a fragrance chosen from diphenyl methane, diphenyl oxide, 2-methyl naphthyl ether and mixtures thereof,
wherein the bleaching agent is a liquid, aqueous bleaching agent.

2. Bleaching agent according to claim 1, wherein the hypochlorite is an alkali metal hypochlorite present in an amount of 0.5 wt. % to 10 wt. %.

3. Bleaching agent according to claim 1, wherein the polyolefin wax is present in an amount of from 0.01 wt. % to 10 wt. %.

4. Bleaching agent according to claim 1, wherein the hypochlorite is an alkali metal hypochlorite present in an amount of 0.1 wt. % to 2 wt. %, and the surfactant is a bleach-resistant surfactant present in an amount of up to 5 wt. % of

5. Bleaching agent according to claim 4, wherein the bleach-resistant surfactant is betaine, amine oxide and/or alkyl ether sulfate.

6. Bleaching agent according to claim 1, wherein the chelating agent is present in an amount of from 0.01 wt. % to 2 wt. %.

7. Bleaching agent according to claim 6, wherein the chelating agent is organophosphonic acid and/or phosphonate.

8. Bleaching agent according to claim 1, wherein the fragrance is present in an amount of 0.0005 wt. % to 0.005 wt. % diphenyl methane, 0.005 wt. % to 0.025 wt. % diphenyl oxide and/or 0.0001 wt. % to 0.005 wt. % of 2-methyl naphthyl ether.

9. Bleaching agent according to claim 1, wherein the fragrance is at least diphenyl methane and diphenyl oxide present in a weight ratio of 1:1 to 1:50.

10. Bleaching agent according to claim 1, wherein the fragrance is at least diphenyl methane and 2-methyl naphthyl ether present in a weight ratio of 50:1 to 1:10.

11. Bleaching agent according to claim 1, wherein the fragrance is at least diphenyl oxide and 2-methyl naphthyl ether present in a weight ratio of 250:1 to 1:1.

12. Bleaching agent according to claim 1, wherein the silicate is present in an amount of from 0.5 wt. % to 2 wt. %.

13. Bleaching agent according to claim 12, wherein the silicate is alkali metal silicate and/or carbonate.

14. Method of bleaching soiling on textiles and/or hard surfaces comprising apply the bleaching agent according to claim 1 to the textile and/or hard surface.

15. Method of bleaching according to claim 14, wherein the bleaching agent leaves less chlorine bleaching agent odor on human skin contacted with the agent than an agent without the fragrances of the bleaching agent according to claim 1.
